(19) United States
(12) Patent Application Publication
(10) Pub. No.: US 2007/0274648 A1
(43) Pub. Date: Nov. 29, 2007

(54) Fiber optic withy light device

(76) Inventor: Tin Ying Ip, Hong Kong (CN)

Correspondence Address: ERIC HANSCOM, 7395 PORTAGE WAY, CARLSBAD, CA, 92011, US

(21) Appl. No.: 11/479,512

(22) Filed: Jun. 30, 2006

(30) Foreign Application Priority Data
Apr. 27, 2006 (CN) 200620058178.2

(51) Int. Cl. G02B 6/04

(52) U.S. Cl. 385/115

(57) ABSTRACT

A fiber optic light device includes a power supply, circuit control, light source, fiber optic bunch, and base. The power supply includes a power supply transformer and power cord. The light source can be formed by LEDs or tungsten filament bulbs. The fiber optic bunch is comprised of a bunch of fiber optic elements. Each fiber optic element comprises an outer tubing, preferably plastic, containing a piece of wire surrounded by at least one fiber optic cable, which may have several fiber optics. The wire supports the fiber optic element so that it can be bent into various shapes. The lower end of the fiber optic bunch is closely positioned to the light source so light emitted by the light source and transmitted through the fiber optics produce light spots throughout the fiber optic element. A flashing control circuit can cause the light emitted to be constant or flashing.

### CROSS REFERENCE TO RELATED APPLICATIONS

None.

### STATEMENT REGARDING FEDERALLY SPONSORED RESEARCH OR DEVELOPMENT

This invention was not federally sponsored.

### PRIORITY

This application claims priority to Chinese patent application number 200620058178.2, filed on Apr. 27, 2006.

### BACKGROUND OF INVENTION

1. Field of the Invention

The embodiments of the invention relate to the field of decorative lights. More specifically, the embodiments of the present invention relate to a fiber optic withy light device for both indoor and outdoor use.

2. Description of the Related Art

Since the event of the light bulb, people have attempted to find new and unique ways to create festive atmospheres, both indoor and outdoor, through the use of lighting. For example, decorative lights have been placed on top of furniture, in ceilings, on walls, in rooms, and in several other locations within the home.

Lights have also been placed next to walkways and hung from patio covers and gazebos to provide a more festive outdoor setting.

Current decorative lights are generally constructed with plain bulbs and simple lampshades. These lights, while providing great functional aspects, often lack in originality of construction and in light source. Also, prior art lighting devices have not offered the ability to quickly and efficiently configure the device to emit directed light in various specific directions. Further, the prior art decorative lights have not been able to satisfy the increasing consumer demand for aesthetic perception in the visual effect that is in-tune with the surrounding visual atmosphere.

Therefore, there is a current need for a decorative lighting device that can provide a festive indoor and outdoor atmosphere that is convenient to use, can be configured to direct light in several directions, is aesthetically pleasing, and utilizes new and improved lighting techniques.

In this respect, before explaining at least one embodiment of the invention in detail it is to be understood that the embodiments of the invention are not limited in their application to the details of construction and to the arrangement of the components set forth in the following description or illustrated in the drawings. The embodiments of the invention are capable of being practiced and carried out in various ways. In addition, it is to be understood that the phraseology and terminology employed herein are for the purpose of description and should not be regarded as limiting.

### BRIEF SUMMARY OF INVENTION

It is a primary advantage of the embodiments of the invention to provide a decorative light device that can be used to provide a festive atmosphere for both indoor and outdoor settings.

It is another advantage of the embodiments of the invention to provide a decorative light device that is easy to install and use.

It is a further advantage of the embodiments of the invention to provide a decorative light device that can be quickly and efficiently manufactured.

It is a yet a further advantage of the embodiments of the invention to provide a decorative light device that utilizes new and improved lighting technology.

It is still yet a further advantage of the embodiments of the invention to provide a decorative light device that has dynamic lighting capabilities.

It is another advantage of the embodiments of the invention to provide a decorative light that allows the user to program the light to change the color of the light emitted at periodic intervals.

It is still a further advantage of the embodiments of the invention to provide a decorative light that can automatically change the color of the light emitted at periodic intervals.

It is yet another advantage of the embodiments of the invention to provide a decorative light device that emits soft and elegant light that is visually appealing to the eye.

It is still yet a further advantage of the embodiments of the invention to provide a new and unique apparatus to the field of decorative lighting devices.

These advantages and other advantages and features of the embodiments of the invention will be apparent to one skilled in the art from the disclosure of the present embodiments as set forth herein.

The preferred embodiment of the invention provides a fiber optic withy light device comprised of power supply system, a circuit control system, a light source system, a fiber optic bunch system and a base system. The power supply system includes power supply transformer and power supply cord. The light source system may be formed by LEDs or by other tungsten filament bulbs. The fiber optic bunch system is composed of a bunch of fiber optic elements. Each fiber optic element comprises an outer tubing, preferably plastic, containing a piece of wire surrounded by at least one fiber optic cable. The wire is used to support the fiber optic element so that the fiber optic element can be bent by the user into various shapes to form different configurations. The lower end of the fiber optic bunch is closely positioned near the light source system so that the light waves emitted by the light source system and transmitted through the fiber optics produce light spots in various places in the fiber optic element.

Another embodiment of the invention provides a fiber optic withy light device comprised of power supply system, a circuit control system, a light source system, a fiber optic bunch system and a base system. The power supply system includes power supply transformer and power supply cord. The light source system may be formed by LEDs or by other tungsten filament bulbs. The fiber optic bunch system is composed of a bunch of fiber optic elements. Each fiber optic element comprises an outer tubing, preferably plastic, containing a piece of wire surrounded by at least one fiber optic cable. The wire is used to support the fiber optic element so that the fiber optic element can be bent by the user into various shapes to form different configurations. The lower end of the fiber optic bunch is closely positioned near the light source system so that the light waves emitted by the light source system and transmitted through the fiber optics produce light spots in various places in the fiber optic element.

A flashing control circuit is connected between the power supply system and the light source system. The flashing control circuit controls the light spots emitted by the fiber optics cables. The flashing control circuit can automatically be set to cause the light to flash in various preset flashing patterns or remain constant. The flashing control circuit can also be manually set to allow the operator to modify the timing of the flashing.

Another embodiment of the invention provides a fiber optic withy light device comprised of power supply system, a circuit control system, a light source system, a fiber optic bunch system and a base system. The power supply system includes power supply transformer and power supply cord. The light source system may be formed by LEDs or by other tungsten filament bulbs. The fiber optic bunch system is composed of a bunch of fiber optic elements. Each fiber optic element comprises an outer tubing, preferably plastic, containing a piece of wire surrounded by at least one fiber optic cable. The wire is used to support the fiber optic element so that the fiber optic element can be bent by the user into various shapes to form different configurations. The lower end of the fiber optic bunch is closely positioned near the light source system so that the light waves emitted by the light source system and transmitted through the fiber optics produce light spots in various places in the fiber optic element.

A flashing control circuit is connected between the power supply system and the light source system. The flashing control circuit controls the light spots emitted by the fiber optics. The flashing control circuit can automatically be set to cause the light to flash in various preset flashing patterns or remain constant. The flashing control circuit can also be manually set to allow the operator to modify the timing of the flashing. The flashing control circuit can also be automatically set, or can also be user programmed, to flash one color of light for a set period and other colors of light for other periods of time.

Another embodiment of the invention provides a fiber optic withy light device comprised of power supply system, a circuit control system, a light source system, a fiber optic bunch system and a base system. The power supply system includes power supply transformer and power supply cord. The light source system may be formed by LEDs or by other tungsten filament bulbs. The fiber optic bunch system is composed of a bunch of fiber optic elements. Each fiber optic element comprises an outer tubing, preferably plastic, containing a piece of wire surrounded by at least one fiber optic cable. Each fiber optic cable can include at least one fiber optic located therein. Preferably, each fiber optic cable includes a plurality of fiber optics located therein, each of the plurality of fiber optics being of different length. The wire is used to support the fiber optic element so that the fiber optic element can be bent by the user into various shapes to form different configurations. The lower end of the fiber optic bunch is closely positioned near the light source system so that the light waves emitted by the light source system and transmitted through the fiber optics produce light spots in various places in the fiber optic element.

A flashing control circuit is connected between the power supply system and the light source system. The flashing control circuit controls the light spots emitted by the fiber optics. The flashing control circuit can automatically be set to cause the light to flash in various preset flashing patterns or remain constant. The flashing control circuit can also be manually set to allow the operator to modify the timing of the flashing. The flashing control circuit can also be automatically set, or can also be user programmed, to flash one color of light for a set period and other colors of light for other periods of time.

There has thus been outlined, rather broadly, features of the embodiments of the invention in order that the detailed description thereof may be better understood, and in order that the present contribution to the art may be better appreciated. There are additional features of the embodiments of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of the embodiments of the invention.

FIG. 1 shows a perspective view of the preferred embodiment of the fiber optic withy light device.

FIG. 2 shows a bottom view of the preferred embodiment of the fiber optic withy light device with the power cord detached.

FIG. 3 shows a top view of the preferred embodiment of the fiber optic withy light device with the power cord detached.

FIG. 4 shows an exploded view of the preferred embodiment of the fiber optic withy light device.

FIG. 5 shows a top view of the light source attached to the location disk.

FIG. 6 shows a top view of a vertical cross-section of a fiber optic element, illustrating an arrangement of fiber optic cables around a metal wire.

FIG. 7 shows a side view of a fiber optic element, illustrating the various lengths of the fiber optic cables contained within the fiber optic element.

FIG. 8 shows a cross-section view of the preferred embodiment of the fiber optic withy light device.

FIG. 9 shows a schematic of the electric circuitry contained within the preferred embodiment of the fiber optic withy light device.

### DETAILED DESCRIPTION OF THE INVENTION

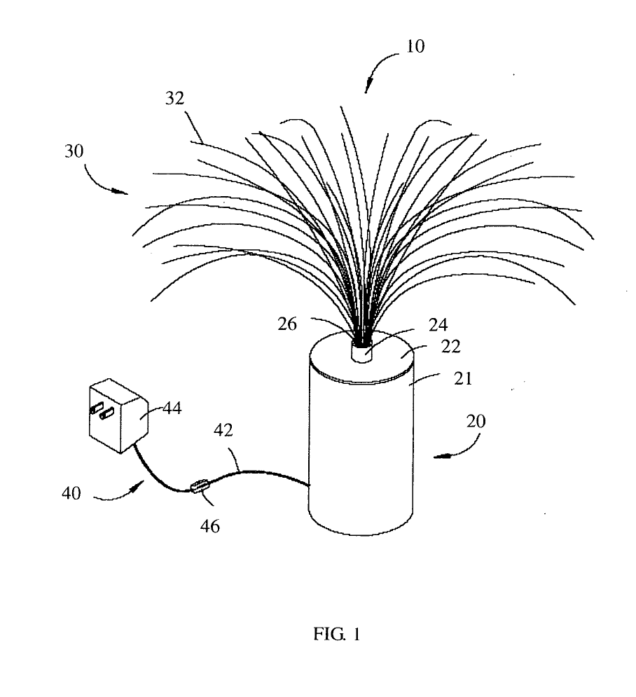

Referring now to the drawings, wherein similar parts are identified by like reference numerals, FIG. 1 shows a perspective view of the preferred embodiment of the fiber optic withy light device 10. Device 10 includes a base portion 20, a light portion 30, and a power transmission means 40. Base portion 20 includes a base 21 that is preferably cylindrical in shape and contains a removable top section 22. However, base 21 can also comprise various shapes such as spherical, rectangular, circular, trapezoidal, hexagonal, octagonal, triangular, square, polygonal, or other shapes as would be recognized by one with ordinary skill in the art. Top section 22 contains a raised lip 24 bounding a centrally-located opening 26. Raised lip 24 can vary in height to providing an opening 26 that can support a light portion 30 of various sizes. Opening 26 is preferably circular in shape, but can also be other shapes to secure light portions 30 of various cross-section shapes.

Light portion 30 is preferably comprised of a plurality of fiber optic elements 32. Fiber optic elements 32 can be comprised of translucent tube having a fiber optic cable and a metal wire therein (see FIG. 6), whereby a user can bend the wire to cause the tube to be oriented in a particular position. Fiber optic elements 32 can also be comprised of a translucent tube having more than one fiber optic cable positioned therein, surrounding a wire also located within the tube, whereby a user can bend the wire to cause the tube to be oriented in a particular position. The fiber optic elements can have more than one support structure therein to provide more flexibility and stability. The fiber optic cables can be all the same length or different lengths to achieve differing light emissions. The tube can be any type of translucent and deformable material, such as plastic. The wire can be any type of wire, including metal, that is flexible, durable, and does not interfere with the light transmission within the fiber optic cable.

Power transmission means 40 preferably comprises a power cord 42 attached to a power adapter 44. Power cord 42 runs through base 21 and connects to power supply circuitry 50 located within base 21. Power supply circuitry preferably operates at 1 Watts and at 12 Volts. Power cord 42 can also include a control switch 46 located therein. Control switch 46 allows a user to turn the device 10 on or off. In other embodiments, control switch 46 also allows the user to select from different lighting features by sending signals to control circuit 50 that can change the color and/or duration of the light emitted. For example, a user can choose a steady emission of white light, a flashing emission of green light, or a combination of a steady and flashing light emission of red light, blue light, and yellow light. The user can also choose to set the light to turn on and off at various periods. For example, the user can choose to set the light to turn on for one hour, then off for an hour, then on again for another hour. In one embodiment, control switch 46 can comprise a box with a wheel device mounted substantially therein, whereby a user rotates the wheel until the wheel “clicks”, causing the device to change modes. Control switch 46 can also comprise a button, wherein multiple pushes of the button can cause the device to changes modes. Control switch 46 can also be comprised of other switch means as would be recognized by one with ordinary skill in the art.

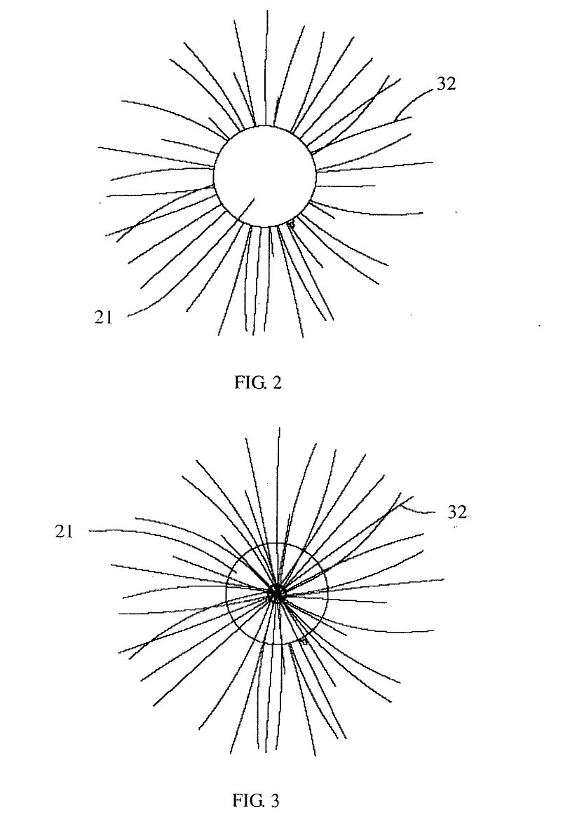

FIG. 2 shows a bottom view of device 10 with power cord 40 detached, illustrating the location of base 21 in relation to fiber optic elements 32.

FIG. 3 shows a top view of device 10 with power cord 40 detached, illustrating the location of top section 22 in relation to fiber optic elements 32.

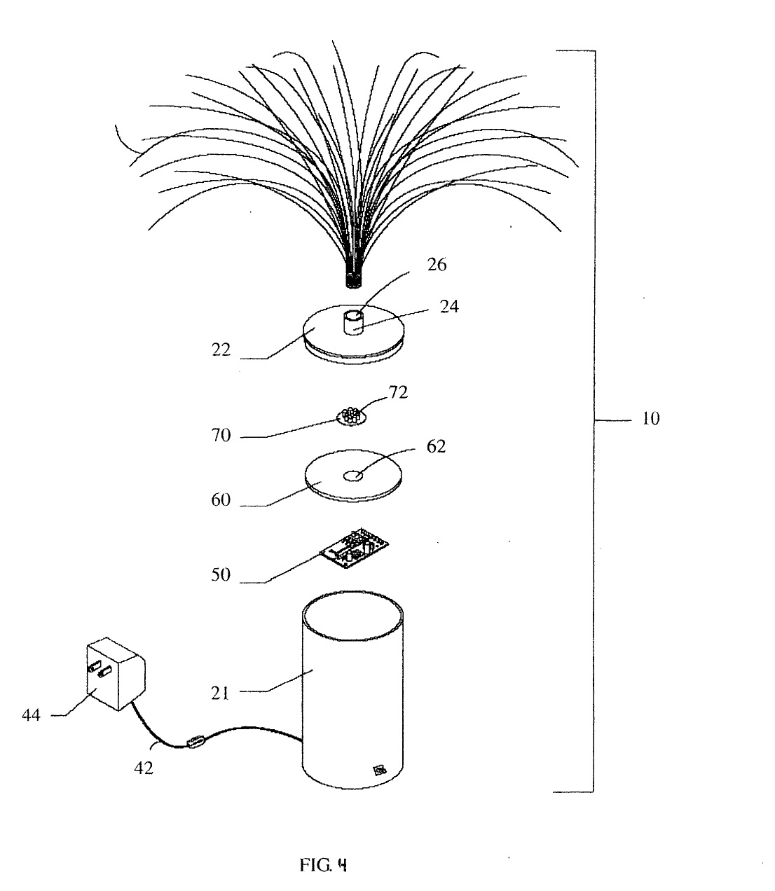

FIG. 4 shows an exploded view of device 10. This figure illustrates the various parts of device 10, in particular the positioning of control circuit 50, location disk 60, and light source 70 within base 21. Control circuit 50 can control whether or not light is emitted from light source 70. In other embodiments, control circuit 50 can also control the duration of the light emitted and the color of the light emitted. For example, light source 70 can be programmed to emit light in a flashing pattern or can be programmed to emit light of one color for a certain time period and then emit light of a different color for another time period. Location disk 60 serves to align light source 60 with the bottom end of light portion 30. This allows the maximum amount of light emitted from light source 60 to directly reach light portion 30 to provide a brighter light emitted from device 10. Location disk 60 contains a light source receiving portion 62 located therein for receiving light source 70. Preferably, light source receiving portion 62 is circular in shape and centrally located within location disk 60 to correspond with the centrally located opening 26 in top section 22. However, location disk 60 can contain more than one light source receiving portion 62 of different shapes and located in different positions within location disk 60.

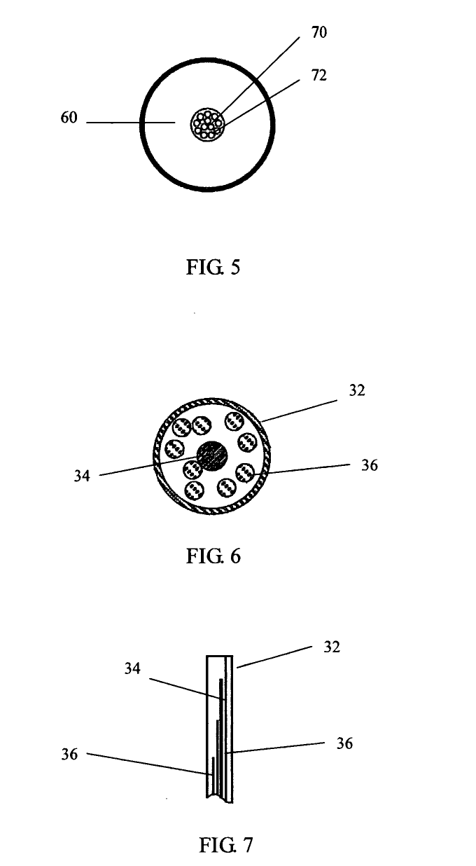

FIG. 5 shows a top view of light source 70 attached to location disk 60. Light source 70 contains at least one LED 72 disposed thereon. Preferably, light source 70 contains a plurality of LEDs 72 disposed thereon. LEDs 72 can comprise similar types of LEDs that can emit the same color light, or LEDs 72 can comprise a mixture of different LEDs to emit various color lights. LEDs 72 can be various sizes and shapes to achieve the desired lighting and power consumption characteristics.

FIG. 6 shows a top view of a vertical cross-section of a fiber optic element 32. Fiber optic element 32 can include at least one fiber optic cable 36 disposed around a wire 34. Preferably, fiber optic element 32 includes a plurality of fiber optic cables 36 disposed around wire 34. Fiber optic cables 36 can be disposed around wire 34 in varying patterns, or in an arranged fashion to achieve a desired lighting effect. In another embodiment, fiber optic cables 36 can also include at least one fiber optic therein. Preferably, each of the fiber optic cables 36 can include a plurality of fiber optics therein, each fiber optic being of a different length. This allows for more illumination points throughout each of the fiber optic elements 32.

FIG. 7 shows a side view of a fiber optic element 32. Fiber optic element 32 can contain fiber optic cables 36 having various lengths, allowing fiber optic element 32 to have many illumination points. Because fiber optic element 32 can have more than one fiber optic cable 36, and each fiber optic cable 36 can be a different length, it is possible to provide different colored lights at different points in each fiber optic element 32.

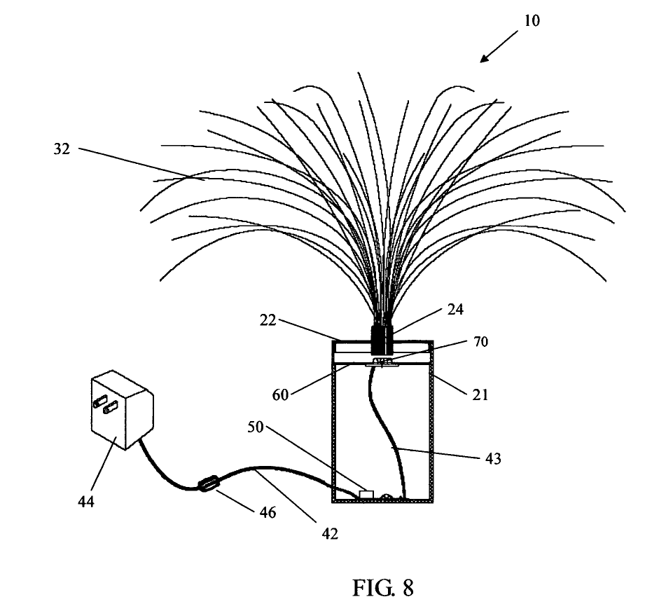

FIG. 8 shows a cross-section view of device 10. This figure illustrates the preferred location of control circuit 50, location disk 60, and light source 70 within base 21. A wire 43 is included within base 21 to connect the control circuit 50 to light source 70.

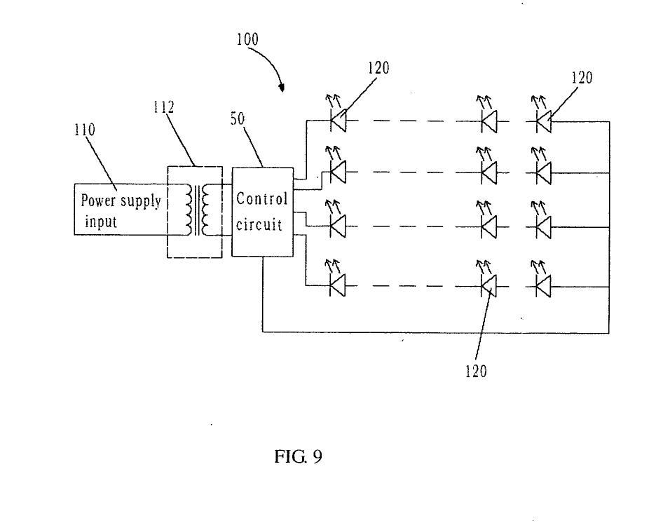

FIG. 9 shows a schematic of the electric circuitry 100 contained within the preferred embodiment of the fiber optic withy light set. Electric circuitry 100 includes power supply input 110 feeding a transformer 112 that provides input to control circuit 50. Control circuit 50 drives many diodes 120 that are preferably connected in parallel. There can be few or many diodes 120 controlled by control circuit 50, depending on the size of device 10. Diodes 120 are preferably light emitting diodes, but can be other diodes as recognized by one with ordinary skill in the art. Further, each of diodes 120 can emit different wavelengths to produce various colors of light, or each of diodes 120 can emit the same wavelength to produce the same color of light. Control circuit 50 can also control the duration of the emission of light as well as the timing and sequencing of the flashing of the lights.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description, together with the advantages of the invention and the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

What is claimed is:

1. A fiber optic light device comprising:
a) a base portion;
b) a light portion attached to the base portion, the light portion comprising a plurality of substantially translucent fiber optic elements, each of the substantially translucent fiber optic elements having at least one fiber optic cable located therein;
c) a light source located within the base portion; and
d) a power supply electrically connected to the light source
whereby the power supply delivers electricity to the light source, causing the light source to emit light to the at least one fiber optic cable located within each of the plurality of substantially translucent fiber optic elements, causing light to emit from each of the at least one fiber optic cables.

2. The fiber optic light device of claim 1, wherein the light portion is removably attached to the base portion.

3. The fiber optic light device of claim 1, wherein the light source is comprised of at least one diode.

4. The fiber optic light device of claim 1, wherein the at least one fiber optic cable is a plurality of cables, each of the plurality of cables having a different length.

5. The fiber optic light device of claim 1, wherein the at least one fiber optic cable is a plurality of fiber optic cables, each of the plurality of fiber optic cables having at least one fiber optic located therein.

6. The fiber optic light device of claim 5, wherein the at least one fiber optic is a plurality of fiber optics, each of the plurality of fiber optics having a different length.

7. The fiber optic light device of claim 1, wherein each of the plurality of substantially translucent fiber optic elements further include at least one support structure therein, whereby a user can manipulate the support structure to cause the fiber optic element to be oriented in a particular position.

8. The fiber optic light device of claim 1, wherein the light source is electrically connected to a control circuit, whereby the control circuit can vary the light emitted from the light source.

9. The fiber optic light device of claim 8, wherein the control circuit can vary the duration of the light emitted from the light source.

10. The fiber optic light device of claim 8, wherein the control circuit can vary the color of the light emitted from the light source.

11. A fiber optic light device comprising:
a) a base portion, the base portion having a top section having a raised lip defining an opening;
b) a light portion removably attached to the opening of the base portion, the light portion comprising a plurality of substantially translucent fiber optic elements each having a plurality of fiber optic cables, each of the plurality of cables having a different length;
c) a light source located within the base portion, the light source comprising at least one diode; and
d) a power supply electrically connected to the light source
whereby the power supply delivers electricity to the light source, causing the light source to emit light to the plurality of fiber optic cables located within each of the plurality of substantially translucent fiber optic elements, causing light to emit from each of the plurality of fiber optic cables.

12. The fiber optic light device of claim 11, wherein the at least one diode is a plurality of diodes, each of the plurality of diodes comprising a diode capable of emitting a different color light.

13. The fiber optic light device of claim 11, wherein the light source is electrically connected to a control circuit, whereby the control circuit can vary the light emitted from the light source.

14. The fiber optic light device of claim 11 further comprising a control switch electrically connected to the control circuit for allowing a user to manually vary the light emitted from the light source.

15. The fiber optic light device of claim 11, wherein each of the plurality of fiber optic cables contains at least one fiber optic located therein.

16. The fiber optic light device of claim 15, wherein the at least one fiber optic is a plurality of fiber optics, each of the plurality of fiber optics having a different length.

17. A fiber optic element for use with a light device comprising:
a) a substantially translucent outer covering;
b) at least one support structure located within the substantially translucent outer covering, whereby a user can manipulate the at least one support structure to cause the fiber optic element to be oriented in a particular position; and
c) at least one fiber optic cable located within the substantially translucent outer covering.

18. The fiber optic element for use with a light device of claim 17, wherein the at least one fiber optic cable is a plurality of fiber optic cables, each of the plurality of fiber optic cables having a different length.

19. The fiber optic element for use with a light device of claim 17, wherein the at least one fiber optic cable is a plurality of fiber optic cables, each of the plurality of fiber optic cables having at least one fiber optic located therein.

20. The fiber optic element for use with a light device of claim 19, wherein the at least one fiber optic is a plurality of fiber optics, each of the plurality of fiber optics having a different length.
